(19) United States
(12) Patent Application Publication
(10) Pub. No.: US 2013/0010914 A1
(43) Pub. Date: Jan. 10, 2013

(54) COMPOSITE MATERIALS, BODIES AND NUCLEAR FUELS INCLUDING METAL OXIDE AND SILICON CARBIDE AND METHODS OF FORMING SAME

(75) Inventors: John E. Garnier, Idaho Falls, ID (US); Michael V. Glazoff, Idaho Falls, ID (US); Sergey Rashkeev, Idaho Falls, ID (US); George W. Griffith, Idaho Falls, ID (US)

(73) Assignee: BATTELLE ENERGY ALLIANCE, LLC, Idaho Falls, ID (US)

(21) Appl. No.: 13/178,854

(22) Filed: Jul. 8, 2011

(51) Int. Cl. G21C 3/02; G21C 3/16

(52) U.S. Cl. 376/412; 264/5

(57) ABSTRACT

Methods of forming composite bodies and materials including a metal oxide, such as, uranium dioxide, and silicon carbide are disclosed. The composite materials may be formed from a metal oxide powder, a silicon carbide powder and, optionally, a carbon powder. For example, the metal oxide powder, the silicon carbide powder and the carbon powder, if present, may each be combined with a binder and may be deposited in succession to form a precursor structure. Segments of the precursor structure may be removed and pressed together to form a multi-matrix material that includes interlaced regions of material including at least one of the metal oxide powder, the silicon carbide powder and, optionally, the carbon powder. The segments may be extruded or coextruded with another material, such as, a silicon carbide material, to form a green body. The green body may be sintered to form the composite bodies and materials having a desired final density.

### STATEMENT REGARDING FEDERALLY SPONSORED RESEARCH OR DEVELOPMENT

This invention was made with government support under Contract Number DE-AC07-051D14517 awarded by the United States Department of Energy. The government has certain rights in the invention.

### TECHNICAL FIELD

Embodiments of the present disclosure relate to methods of fabricating composite materials and bodies including a metal oxide material and a silicon carbide material, and to materials and bodies formed by such methods.

### BACKGROUND

Metallic uranium (U) is suitable as a fuel for nuclear reactors because it provides a maximum number of uranium atoms per unit volume. However, because uranium has poor mechanical properties and exhibits great susceptibility to radiation damage, uranium metal fuel is not used in power reactors in many countries.

Wide-spread use of uranium dioxide (UO₂), a ceramic of uranium which is the most common fuel material in commercial power reactors, is attributed to its desirable properties, including a high density of uranium atoms for producing nuclear reactions, inertness and insolubility in high temperature water and a high melting point (2865° C.). The high melting point and corrosion resistance of uranium dioxide make this compound suitable for use in high temperature water-cooled reactors, where cladding failure caused by reactivity between the fuel and water may be catastrophic. Uranium dioxide also retains a large proportion of the fission gases, provided the temperature does not exceed about 1000° C.

Although uranium dioxide is satisfactory for use in some reactors, it has several significant drawbacks, which limit its overall effectiveness. For example, uranium dioxide has a low thermal conductivity in comparison to other fuel materials (e.g., zirconium metal). Although uranium dioxide is stable at high temperatures, its thermal conductivity decreases as the temperatures to which it is exposed increase. The inherent low thermal conductivity of uranium dioxide prevents this material from effectively dissipating heat, which imposes significant limitations on nuclear reactor operations and compromises reactor operations during transient events, such as those resulting from loss of reactor core coolant.

Conventional uranium dioxide based nuclear fuel has a pelletized form (i.e., fuel pellet) positioned within an external metal cladding (e.g., zircaloy alloy) surrounded by a coolant layer for controlled external cooling of the fuel, prevention of pellet and cladding degradation. Heat produced within the uranium dioxide fuel passes through a fuel/cladding gap into the cladding, where it is removed by the coolant layer. Under steady state conditions the external coolant layer surrounds the cladding to provide consistent temperature for removal of heat generated by the uranium dioxide fuel. During a transient condition, portions of the coolant layer that flow past the cladding may become uneven, causing local disruption in steady removal of heat from the fuel pellet. Operational safety may be compromised during a loss-of-coolant condition as heat in the uranium dioxide based nuclear fuel accumulates. As this condition continues the uranium dioxide fuel may eventually be unable to withstand increased temperatures.

In addition, the uranium dioxide fuels are limited in their limited burn-up capacity. The term “burnup” as used herein means and includes depletion of fissionable content. As burning occurs, certain radioactive isotopes are produced which spontaneously emit fast neutrons. The greater the burnup, the greater will be the production of these isotopes, and thus the emission rate of these fast neutrons will increase. As mechanical load-carrying capacity of the cladding is reduced, due to external hydrogen pick up from the coolant layer, formation of localized internal stress cracks may form as a result of mechanical interaction between the uranium dioxide fuel and the cladding. An increase in fission gas released inside the cladding may further increase mechanical stress on the cladding. Such mechanical stress may lead to a substantial reduction in the lifetime of the external cladding and, more seriously, may lead to failure of the external metal cladding.

Given the inherent low thermal conductivity of uranium dioxide, it is necessary to operate the reactors using uranium dioxide fuels at a reduced, less than optimum power level to maintain acceptable overall plant safety margins. Even at the reduced power level, the low thermal conductivity of the uranium dioxide fuel leads to elevated internal fuel temperatures that may locally stress surrounding cladding, thus limiting overall lifetime of the cladding. Several attempts have been made to increase the thermal conductivity of uranium dioxide fuels, but such attempts have been largely successful. Despite its drawbacks, uranium dioxide, in its unmodified form, remains the dominant fuel for nuclear power reactors.

### BRIEF SUMMARY

In some embodiments, the present disclosure includes methods of forming a composite material. The methods may include forming a first region comprising a metal oxide powder adjacent a second region comprising a silicon carbide powder to form a precursor structure, removing portions of the precursor structure to form a plurality of segments, each segment comprising a portion of the first region and of the second region, aggregating the plurality of segments to form a green body and sintering the green body to form a sintered body.

The methods of forming the composite material may also include forming at least one layer of silicon carbide particles, forming at least one layer of metal oxide particles over the at least one layer of silicon carbide particles to form a stacked structure, shaping the stacked structure into a cylindrical rod, removing portions of the cylindrical rod to form a plurality of segments, each segment comprising a portion of each of the at least one layer of silicon carbide particles and the at least one layer of the metal oxide particles, applying pressure to the plurality of segments to form a green body and sintering the green body to form a sintered body comprising regions of metal oxide and silicon carbide.

In further embodiments, the present disclosure includes methods of forming a nuclear fuel. Such methods include forming a uranium dioxide material over a silicon carbide material to form a precursor structure, removing portions of the precursor structure to form a plurality of segments, applying pressure to the plurality of segments to form a green body and sintering the green body to form a sintered body comprising regions of metal oxide and silicon carbide.

In yet further embodiments, the present disclosure includes green bodies. Such a green body may include metal oxide regions comprising particles of a metal oxide dispersed in a matrix and silicon carbide regions at least substantially interlaced with the metal oxide regions and comprising silicon carbide particles dispersed in another matrix.

In additional embodiments, the present disclosure includes nuclear fuels. Such a nuclear fuel may include a multi-matrix composite material having a shape substantially corresponding to a nuclear fuel tube. The multi-matrix material may include a plurality of uranium dioxide regions and a plurality of silicon carbide regions interlaced with the plurality of uranium carbide regions.

### BRIEF DESCRIPTION OF THE DRAWINGS

While the specification concludes with claims particularly pointing out and distinctly claiming that which is regarded as the present disclosure, the advantages of this invention may be more readily ascertained from the following description of the disclosure when read in conjunction with the accompanying drawings in which:

FIGS. 1 through 4 are simplified views illustrating embodiments of a method of forming a green body comprising a multi-matrix material according to the present disclosure;

FIGS. 5A through 5C are enlarged views illustrating embodiments of the multi-matrix material shown in rectangle X in FIG. 4, which may be formed in accordance with embodiments of the present disclosure; and

FIGS. 6 through 7D are cross-sectional views of green bodies, which may be sintered to form a solid three-dimensional body including MO₂/SiC composite material in accordance with embodiments of the present disclosure.

### DETAILED DESCRIPTION

The illustrations presented herein are not meant to be actual views of any particular structure or device, but are merely idealized representations that are employed to describe various embodiments of the present disclosure.

As used herein, the term “composite” means and includes a material formed by combining two or more materials on a macroscopic level. For example, the composite may include a plurality of particles of one or more materials suspended in a matrix of another material. The composite may additionally include interlaced regions of sintered particles of one or more materials.

As used herein, the term “interlaced” means and includes a plurality of regions of material arranged so as to cross one another, passing over and/or under one another.

As used herein, the terms “sinter” and “sintering” mean and include fusion and/or bonding of particles of material to form a monolithic structure.

As used herein, the term “pressureless sintering” means and includes sintering under pressures of about 5 pounds per square inch gauge (psig) or less.

As used herein, the term “densifying” and “densification” mean and include increasing a density of a structure by any means, such as, sintering.

As used herein, the term “isotropic” means and includes having properties that are substantially equal in every direction at a point within a material (i.e., the properties are independent of orientation at a point in the material).

As used herein, the term “anisotropic” means and includes having material properties that are different in three mutually perpendicular directions at a point in the body and, further, has three mutually perpendicular planes of material property symmetry (i.e., the properties are dependent on orientation at a point within the material).

As used herein, the terms “coextruded” and “coextruding” mean and include simultaneously extruding two or more different materials through a single orifice (e.g., a die) so that the materials merge together to form a single article incorporating each of the materials (i.e., a multilayer, laminated or otherwise segmented composite when viewed in section transverse to the direction of coextrusion).

As used herein, the term “green” means and includes a less than fully sintered material. When referring to a body (e.g., a pellet or sphere) of material, the term “green” means and includes a body of material including less than fully sintered material. Green bodies include, for example, bodies formed from particulate matter, as well as bodies formed by partially sintering particulate matter.

As used herein, the term “fully sintered” means sintered to a desirable final density. Fully sintered bodies are bodies that have been sintered to a desirable final density, although they may comprise some level of residual porosity and, hence, may not be fully dense.

Embodiments of the present disclosure include nuclear fuels that are believed to generally provide improved thermal conductivity, safety of nuclear reactor under accident conditions (e.g., loss of coolant accidents) and burn-up capabilities relative to other nuclear fuels known in the art. Methods of forming the nuclear fuels are generally simple and provide uniformity.

Composite bodies and materials that include regions of a metal oxide (MO₂) material, a silicon carbide (SiC) material and, optionally, a carbon (C) material, which are referred to herein as “MO₂/SiC composite materials,” may be manufactured using a metal oxide powder, a silicon carbide powder and, optionally, a carbon powder. The metal oxide powder, the silicon carbide powder and the carbon powder, if present, may each be combined with a binder and may be deposited in succession to form a precursor structure. For example, the precursor structure may include a plurality of regions, each of which includes at least one of the metal oxide powder, the silicon carbide powder or the carbon powder. The precursor structure may be subjected to a machining process to remove segments thereof. The segments may include a region including the metal oxide powder, a region including the silicon carbide powder and a region including the carbon powder, if present. The segments may be aggregated or pressed together to form a green multi-matrix material, which includes interlaced regions of a metal oxide material, a silicon carbide material and the carbon material, if present. The green multi-matrix material may be extruded by itself to form a green body or may be coextruded with another green material to form a green body. The green body may be sintered to form a solid three-dimensional body including the MO₂/SiC composite material having a desired final density. The MO₂/SiC composite material of the solid three-dimensional body may include fully sintered, interlaced regions of the metal oxide material, the silicon carbide material and, if present, the carbon material.

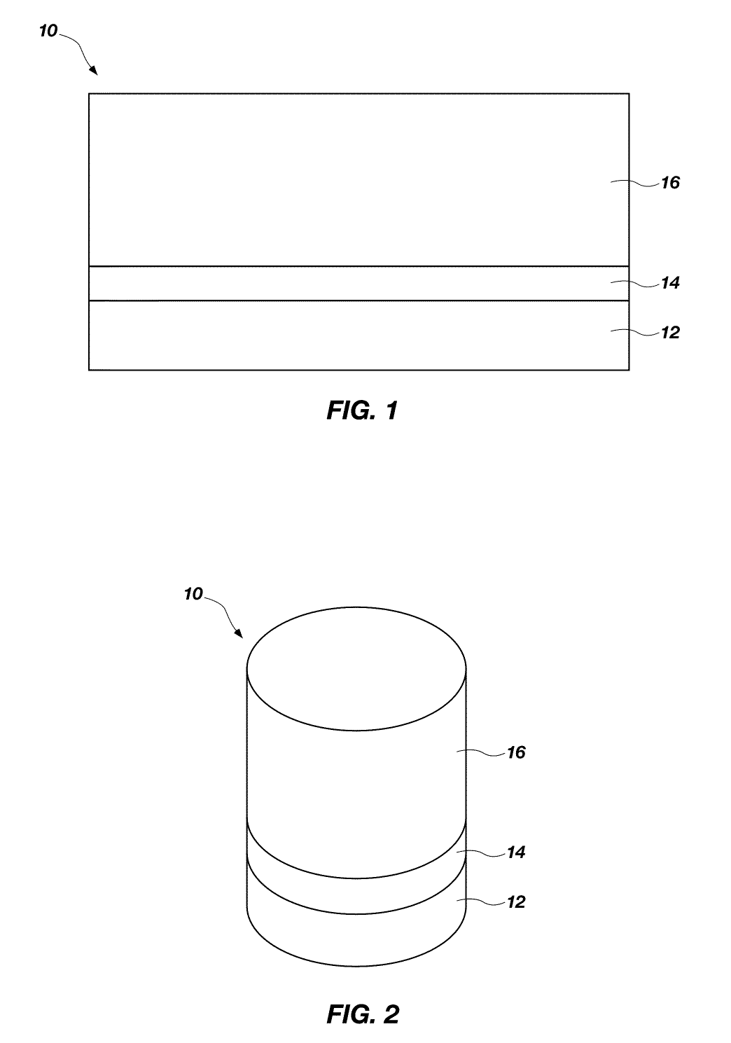

Referring to FIG. 1, a precursor structure 10 may be formed that includes a plurality of regions 12, 14, 16, each of the regions formed from at least one of a metal oxide powder, a silicon carbide powder and a carbon powder. By way of example and not limitation, the precursor structure 10 may be formed to include a region formed from a silicon carbide powder (i.e., a silicon carbide region 12) and a region formed from the metal oxide powder (i.e., metal oxide region 16). The precursor structure 10 may optionally include a region formed from the carbon powder (i.e., carbon region 14). In the precursor structure 10 shown in FIG. 1, the metal oxide region 16 is formed over the carbon region 14 and the carbon region 14 is formed over the silicon carbide region 12. As configured, the silicon carbide region 12, the metal oxide region 16 and, if present, the carbon region 14, may be formed in any order. The silicon carbide region 12, the carbon region 14, and the metal oxide region 16 may each be formed using conventional shape forming processes, such as, pressing process (e.g., a uniaxial pressing process or an isostatic pressing process), a casting process (e.g., a tape casting process or a slip casting process), a spray deposition process or a plastic forming process (e.g., an extrusion process or a compression molding process).

The metal oxide powder may include an oxide of at least one of uranium (U), thorium (Th), cerium (Ce), selenium (Se), rubidium (Rb), palladium (Pd), plutonium (Pu), neptunium (Np), americium (Am), curium (Cu), protactinium (Pa) and radium (Ra). For example, the metal oxide powder may include uranium dioxide (UO₂) particles (i.e., particles that are at least substantially comprised of uranium dioxide). The uranium dioxide may be obtained commercially from Cameco Corporation (Saskatoon, Saskatchewan), GE Hitachi (Wilmington, N.C.), Mistubishi Heavy Industries (Kanagawa, Japan) and AREVA (Paris, France), for example. By way of example and not limitation, the particles of metal oxide powder may have an average particle size (e.g., an average diameter) of less than about 1 μm and, more particularly, between about 0.01 μm and about 0.5 μm.

The silicon carbide powder may include a directly pressable and pressureless-sinterable alpha silicon carbide powder. The silicon carbide powder may be obtained commercially from Alfa Aesar (Ward Hill, Mass.), Superior Graphite (Chicago, Ill.) and Electro Abrasives (Buffalo, N.Y.), for example. By way of example and not limitation, the particles of the silicon carbide powder may have may have an average particle size (e.g., an average diameter) of less than about 0.5 μm and, more particularly, between about 0.01 μm and about 0.3 μm.

The carbon powder may be formed from particles including at least one allotrope of carbon, such as, graphite, amorphous carbon or carbon nanotubes. For example, the carbon powder may comprise a graphite powder. By way of example and not limitation, the particles of the carbon powder may have may have an average particle size (e.g., an average diameter) of less than about 1 μm and, more particularly, between about 0.01 μm and about 0.5 μm.

The silicon carbide and the carbon may exhibit different crystal structures. For example, silicon carbide that exhibits a hexagonal crystal structure is referred to as “alpha silicon carbide” (a-silicon carbide), and silicon carbide that exhibits a zinc blende crystal structure is referred to as “beta silicon carbide” (β-silicon carbide). In some embodiments, the silicon carbide particles may be formed from alpha silicon carbide. In additional embodiments, the silicon carbide particles may be formed from beta silicon carbide. For example, graphite that exhibits a hexagonal crystal structure is referred to as “alpha graphite” (α-graphite), and graphite that exhibits a rhombohedral structure is referred to as “beta graphite” (β-graphite). In some embodiments, the graphite particles may be formed from alpha graphite. In additional embodiments, the graphite particles may be formed from beta graphite.

In some embodiments, the silicon carbide powder, the carbon powder and/or the metal oxide powder may include two or more different modes of particle sizes. In other words, the particles of the silicon carbide powder, the carbon powder and/or the metal oxide powder may exhibit a multi-modal particle size distribution (e.g., a bi-modal, tri-modal, etc., particle size distribution). As a non-limiting example, one or more of the powders may comprise a first group of particles having a first average particle size, a second group of particles having a second average particle size about seven times greater than the first average particle size, and a third group of particles having an average particle size about 35 times greater than the first average particle size. By forming the powders to have a multi-modal particle size distribution, it may be possible to increase the packing density of the powder mixture in a green body formed from the powders.

By way of example and not limitation, the silicon carbide region 12 may be formed by mixing the silicon carbide powder with a liquid medium to form a silicon carbide slurry and forming the silicon carbide slurry over a substrate (not shown). The substrate may be formed from, for example, a fiber structure or a rigid material. The carbon region 14, if present, may be formed by mixing the carbon powder (e.g., graphite powder) with a liquid medium to form a carbon slurry and forming the carbon slurry over the silicon carbide region 12. The metal oxide region 16 may be formed by mixing a metal oxide powder (e.g., a uranium dioxide powder) with a liquid medium to form a metal oxide slurry and forming the metal oxide slurry over the silicon carbide region 12 or, if present, the carbon region 14.

A thickness of each of the silicon carbide region 12, the carbon region 14, if present, and the metal oxide region 16 may be determined based on a desired proportion of each of the silicon carbide, the carbon and the metal oxide in the final MO₂/SiC composite material. For example, each of the regions 12, 14, 16 may be formed as a lamella or a layer having a thickness of between about 1 μm and about 1000 While the precursor structure 10 shown in FIG. 1 includes a plurality of regions 12, 14, 16 formed as stacked layers, the regions 12, 14, 16 may be formed in a variety of configurations, as would be recognized by one of ordinary skill in the art.

Prior to forming the silicon carbide region 12 from the silicon carbide powder, the carbon region 14 from the carbon powder, if present, and the metal oxide region 16 from the metal oxide powder, the silicon carbide powder, the carbon powder and the metal oxide powder may be combined with at least one binder. For example, the binder may be mixed with at least one of the silicon carbide powder, the carbon powder and the metal oxide powder before respectively forming the silicon carbide region 12, the carbon region 14, if present, and the metal oxide region 16. The binder may optionally be deposited before forming each of the regions 12, 14, 16 to improve adhesion of material of the regions 12, 14, 16 to underlying surfaces. For example, a layer of the binder may be formed over at least one of the substrate, the silicon carbide region 12 and the carbon region 14, if present, before forming the overlying region (i.e., the silicon carbide region 12, the carbon region 14, if present, and the metal oxide region 16, respectively). A layer of the binder may also be formed over an exposed surface of the metal oxide region 16. By way of example and not limitation, the binder may be a polymer material, such as, a pre-ceramic polymer or a synthetic rubber. Examples of suitable binders include, but are not limited to, polysilazanes, such as, CERASET® polysilazane 20 (PSZ 20), which is commercially available from KiON Defense Technologies, Inc. (Huntingdon Valley, Pa.) and carboxylated butadiene-nitrile rubber.

Prior to forming the silicon carbide region 12 from the silicon carbide powder and the metal oxide region 16 from the metal oxide powder, one or more sintering agents may be combined with the silicon carbide powder or the metal oxide powder. For example, the sintering agents may be mixed with at least one of the silicon carbide powder, the carbon powder and the metal oxide powder before forming the silicon carbide region 12, the carbon region 14, if present, and the metal oxide region 16. The sintering agents may be included to control shrinkage and densification during the sintering process. Examples of suitable sintering agents include, but are not limited to, silicon dioxide (SiO₂), yttrium oxide (Y₂O₃), titanium dioxide (TiO₂) and a neodymium oxide (Nd₂O₃). For example, the silicon carbide region 12 may include at least one of a titanium dioxide powder and a neodymium powder as a sintering agent to tailor shrinkage and densification during the sintering process. For example, the metal oxide region 16 may include at least one of a silicon dioxide powder and a yttrium oxide powder as a sintering agent.

Prior to forming each of the regions 12, 14, 16, an amount of shrinkage of the material in each of the silicon carbide region 12, the carbon region 14, if present, and the metal oxide region 16 that may occur during sintering may be determined. The proportions of the powders and sintering agents in each of the regions 12, 14, 16 as well as the particle sizes of the powders may be tailored to control such shrinkage. For example, the particle sizes in the powders and proportion of the sintering agents in each of the regions 12, 14, 16 may be tailored such that the shrinkage of the material in each of the silicon carbide region 12, the carbon region 14 and the metal oxide region 16 may be substantially equal (e.g., within 1% by volume or less).

As shown in FIG. 2, the precursor structure 10 including the regions 12, 14, 16 may then be shaped into a cylindrical rod or other desired shape. For example, the precursor structure 10 may be shaped into the cylindrical rod using a conventional roll-forming process. A curing process may then be performed to cure the binder, if present, in the precursor structure 10. The curing process may include exposing the precursor structure 10 to a temperature of between about 80° C. and about 160° C. and, more particularly, about 120° C. The curing process may be performed for between about 15 minutes and about 3 hours. By way of example and not limitation, the precursor structure 10 may include the polysilazane material and the the polysilazane material may be cured by exposing the precursor structure 10 to a temperature of about 120° C. for about 1 hour.

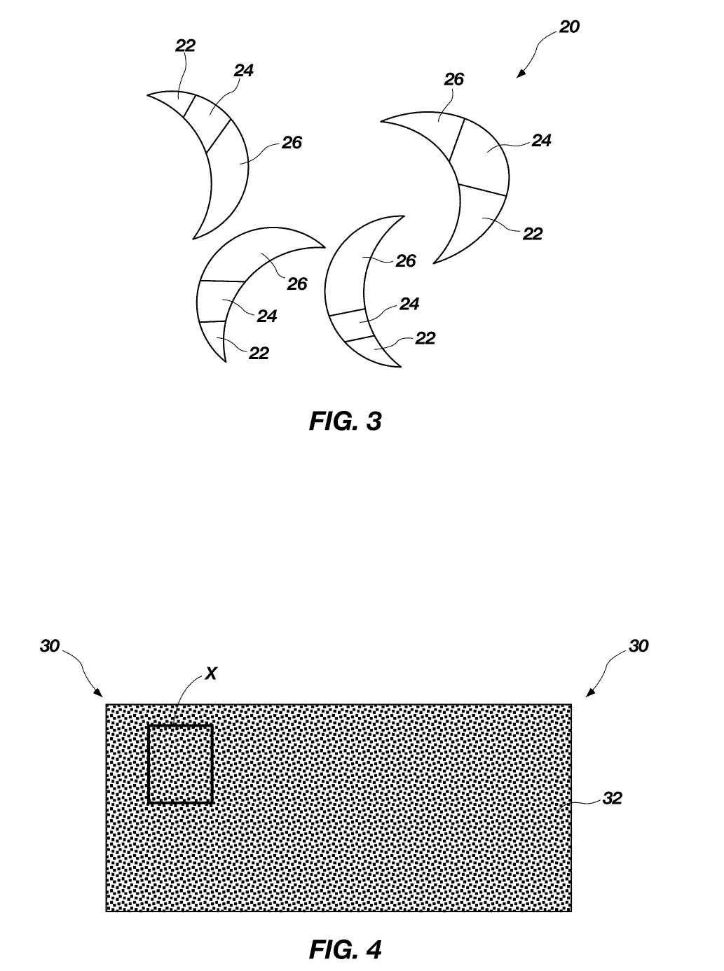

As shown in FIG. 3, portions of the precursor structure 10 may then be removed to form a plurality of segments 20, each segment including metal oxide material 26 from the metal oxide region 16 (FIG. 2), a silicon carbide material 22 from the silicon carbide region 12 (FIG. 2) and a carbon material 24 from the carbon region 14 (FIG. 2), if present. The segments 20 may be removed from the precursor structure 10 (FIG. 2) using a conventional machining process, such as, a turning process performed on a lathe, or a cutting process. By way of example and not limitation, the precursor structure 10 may be placed on a lathe and may be rotated in a first plane about an axis substantially perpendicular to the first plane. As the precursor structure 10 is rotated on the lathe, a cutting tool (e.g., a chisel) may be applied to the precursor structure 10 to remove the portions of the precursor structure 10, forming the segments 20. As the precursor structure 10 is rotated on the lathe, an applied angle of the cutting tool, a pressure applied to the precursor structure 10 by the cutting tool, a speed of rotation of the precursor structure 10, or both, may be adjusted to form the segments 20 having desired dimensions. By way of example and not limitation, each of the segments 20 may have a thickness of between about 0.2 mm and about 0.5 mm, a width of between about 2 mm and about 6 mm and a length of between about 5 mm and about 25 mm.

Referring to FIG. 4, a plurality of the segments 20 (FIG. 3) may then be aggregated and pressure may be applied thereto to form an aggregate structure 30. The aggregate structure 30 may include a green multi-matrix material 32, which includes interlaced regions of the metal oxide material 26, the silicon carbide material 22 and, if present, the carbon material 24 (FIG. 3). The segments 20 may be aggregated and pressed together to form the aggregate structure 30 using, for example, a conventional pressing process (e.g., a uniaxial pressing process or an isostatic pressing process) or a conventional plastic forming process (e.g., an extrusion process or a molding process), the details of which are known in the art and, thus, are not described in detail herein. While the aggregate structure 30 is shown in FIG. 4 as having a rectangular shape, the aggregate structure 30 may be formed to have any simple or complex three-dimensional shape.

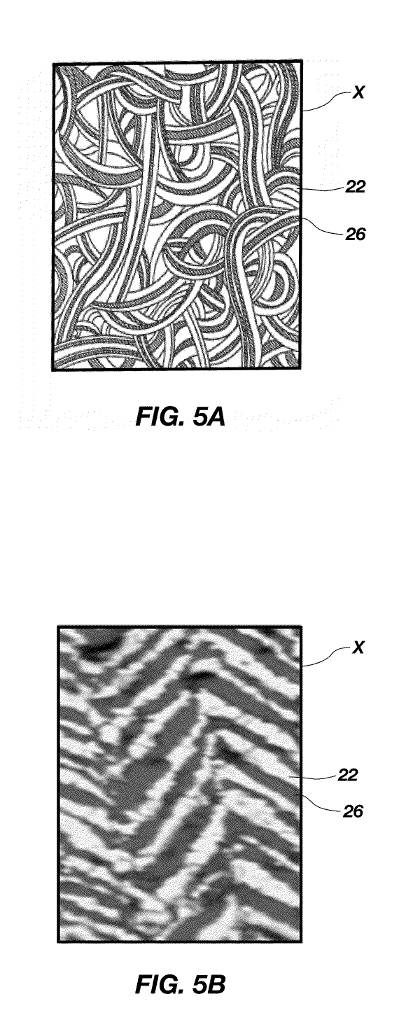

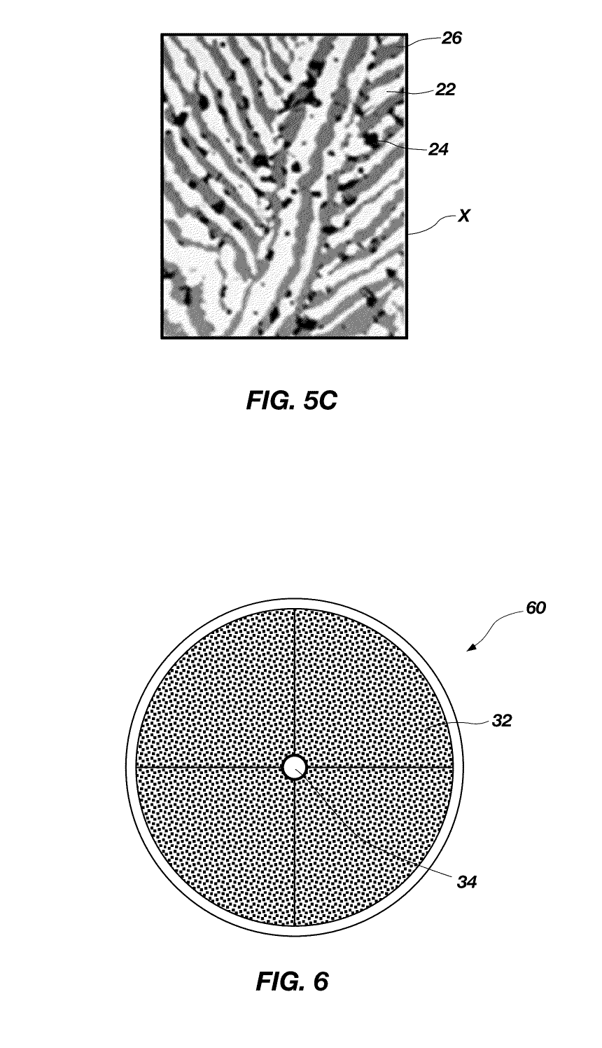

FIGS. 5A through 5C are illustrations of enlarged views of embodiments of portions of green multi-matrix material 32 of the aggregate structure 30 within rectangle X shown in FIG. 4. As shown in FIGS. 5A through 5C, the green multi-matrix material 32 may include a plurality of regions of the metal oxide material 26, the silicon carbide material 22 and, if present, the carbon material 24. The metal oxide material 26, the silicon carbide material 22 and, if present, the carbon material 24 may be interlaced with one another. For example, at least one of the regions of the metal oxide material 26, the silicon carbide material 22 and the carbon material 24 may cross or intertwine with at least another region of the metal oxide material 26, the silicon carbide material 22 and, if present, the carbon material 24 so that the at least one of the metal oxide material 26, the silicon carbide material 22 and the carbon material 24 passes over and/or under the at least another region of the metal oxide material 26, the silicon carbide material 22 and the carbon material 24.

For example, the green multi-matrix material 32 shown in FIGS. 5A and 5B may include the silicon carbide material 22 interlaced with a metal oxide material 26. The green multi-matrix material 32 shown in FIGS. 5C may include the silicon carbide material 22, the carbon material 24 and the metal oxide material 26 interlaced with one another. By way of example and not limitation, the metal oxide material 26 may be formed from uranium dioxide or cerium dioxide. A molar ratio the metal oxide material 26 to the material of the silicon carbide regions in the green multi-matrix material 32 may be between about 95 to 5 and about 5 to 95 and, more particularly, about 75 to 25. The thermal conductivities of B-silicon carbide (about 360 W/m-K at 20° C.), a-silicon carbide (about 490 W/m-K at 20° C.) and graphite (about 80 to 240 W/m-K at 20° C.) are substantially higher than the thermal conductivity of uranium dioxide (about 490 W/m-K at 20° C.). Based on the thermal conductivities of the individual materials, the molar ratios of each of the silicon carbide material 22, the carbon material 24, if present, and the metal oxide material 26 in the green multi-matrix material 32 may be selected to tailor the thermal conductivity of the final MO₂/SiC composite material.

A conventional extrusion process may then be performed to shape the green multi-matrix material 32 of the aggregate structure 30 shown in FIG. 4 into a green body 60 having a desired shape, such as, a pellet or sphere shape, a cross-section of which is shown in FIG. 6.

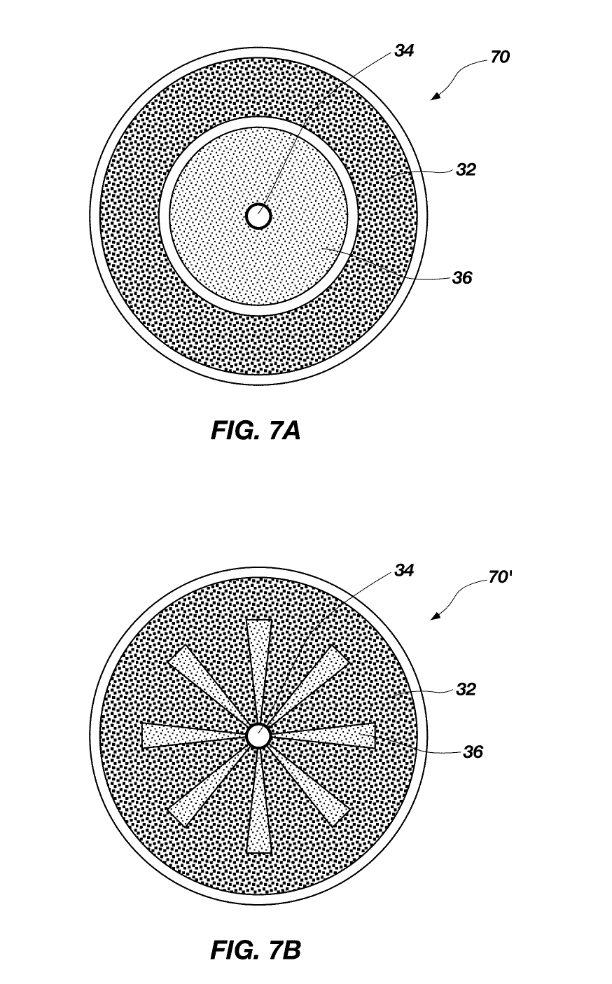

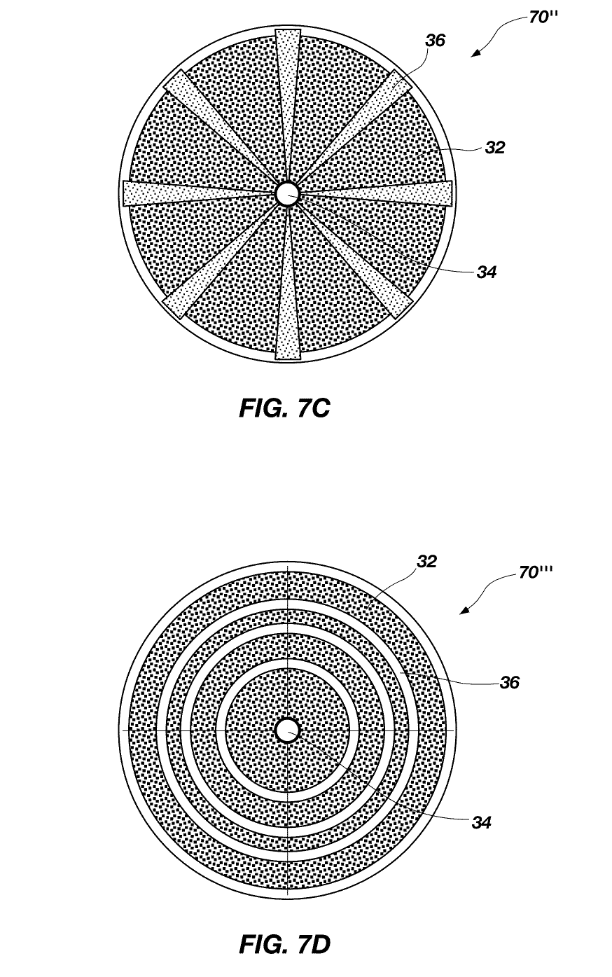

The green multi-matrix material 32 of the aggregate structure 30 shown in FIG. 4 may also be coextruded with at least one other green material to form green bodies 70, 70′, 70″ and 70′″, which are respectively shown in cross-section in FIGS. 7A through 7D. For example, the green material 36 may at least substantially comprise the silicon carbide powder and may be formed by mixing the silicon carbide powder and at least one binder to form a slurry and curing the slurry. The aggregate structure 30 may be coextruded with the green material 36 to form the green bodies 70, 70′, 70″ and 70′″ having a variety of geometric configurations. The green multi-matrix material 32 may exhibit substantially isotropic thermal and mechanical properties due to the interlaced silicon carbide material 22 and a metal oxide material 26. The green material 36 and the green multi-matrix material 32 may be positioned to increase anisotropic character of the thermal and mechanical properties in the green bodies 70, 70′, 70″ and 70′″.

As shown in FIG. 7A, the green body 70 may include a central core region including the green material 36 and an outer region surrounding the central core region and including the green multi-matrix material 32. For example, the green body 70 may be formed by simultaneously extruding the green material 36 through an outer die (not shown) and the green multi-matrix material 32 through an inner die (not shown). In embodiments in which the green material 36 comprises a silicon carbide material and the green multi-matrix material 32 comprises interlaced regions of the silicon carbide material and a metal oxide material comprising uranium dioxide powder, after sintering, the silicon carbide material may insulate the uranium dioxide fuel in the central core region.

As shown in FIGS. 7B and 7C, the green bodies 70′ and 70″ may each include a plurality of wedge-shaped sections of the green material 36 within the green multi-matrix material 32. For example, the green bodies 70′ and 70″ may be formed by simultaneously extruding the green material 36 through an inner die (not shown) having the wedge-shaped pattern and the green multi-matrix material 32 through an outer die (not shown) surrounding the inner die.

As shown in FIG. 7D, the green body 70′″ may include a plurality of ring-shaped sections of the green material 36 disposed within the green multi-matrix material 32. For example, the green body 70′″ may be formed by simultaneously extruding the green material 36 through a plurality of die (not shown), each having a ring-shaped pattern and the green multi-matrix material 32 through another plurality of die (not shown), each surrounding one of the die for forming the ring-shaped sections.

The resulting green bodies 60, 70, 70′, 70″, 70′″, shown in FIGS. 6 through 7D, may have sufficient mechanical strength to withstand conventional machining processes that are conventionally performed after sintering. For example, the green bodies 60, 70, 70′, 70″, 70′″ may be subjected to a machining process to include various features therein, such as a central hole 34. Since the green bodies 60, 70, 70′, 70″, 70′″ have sufficient mechanical strength to withstand such machining process prior to performing a sintering process, the disclosed methods provide simplified manufacturing of nuclear fuels and high volume manufacturing of such nuclear fuels in comparison to conventional processes for forming nuclear fuels.

After the optional machining process has been performed on the green bodies 60, 70, 70′, 70″, 70′″, the green bodies 60, 70, 70′, 70″, 70′″ may be sintered to a desired final density to form sintered three-dimensional solid bodies of a MO₂/SiC composite material. During sintering the silicon carbide material 22 may be converted to a material including particles of the silicon carbide in a matrix of the silicon carbide, the metal oxide material 26 may be converted to a material including particles of the metal oxide in a matrix of the silicon carbide and, if present, the carbon material 24 may be converted to particles of carbon in a matrix of the silicon carbide. Upon sintering, the green bodies 60, 70, 70′, 70″, 70′″ will undergo densification and, hence, shrinkage. As a result, the fully sintered three-dimensional solid body of MO₂/SiC composite material may be smaller than the green bodies 60, 70, 70′, 70″, 70′″.

Prior to sintering, the green bodies 60, 70, 70′, 70″, 70′″ may be subjected to a thermal treatment to remove any organic additives present in the green bodies 60, 70, 70′, 70″, 70′″, and/or to promote cross-linking or polymerization of any polymeric carbon source in the powder mixture (which may impart strength to the green bodies 60, 70, 70′, 70″, 70′″ to facilitate handling and/or machining of the green bodies 60, 70, 70′, 70″, 70′″ if necessary or desirable). By way of example and not limitation, the green bodies 60, 70, 70′, 70″, 70′″ may be heated in air to a temperature of between about 200° C. and about 300° C. and, more particularly, about 242° C., and the temperature may be held to between about eight hours or more.

Sintering may be conducted within a sintering furnace in an inert atmosphere (e.g., argon). Furthermore, the sintering may comprise a low pressure or a pressureless sintering process. For example, the green bodies 60, 70, 70′, 70″, 70′″ may be sintered at a pressure of about 1,000 psig (about 68.9 bar) or less, or even at a pressure of about 5 psig (about 0.34 bar) or less.

As a non-limiting example of a method that may be used to sinter the green bodies 60, 70, 70′, 70″, 70′″, the temperature within a sintering furnace in which the green bodies 60, 70, 70′, 70″, 70′″ are disposed may be increased at a rate of about 10° C. per minute to between about 200° C. and about 600° C. and, more particularly, about 400° C. and may be held for between about 15 minutes and about 3 hours. The temperature within the sintering furnace may then be increased to between about 800° C. and about 1200° C. and, more particularly, about 1000° C. to convert the silicon carbide material to an amorphous state. For example, the green bodies 60, 70, 70′, 70″, 70′″ may be exposed to a temperature of about 1000° C. for about 15 minutes to about 3 hours. As previously discussed, tailoring of the materials (i.e., the metal oxide material 26 and the silicon carbide materials 22, 36 of the green bodies 60, 70, 70′, 70″ and 70′″) provides substantially the same shrinkage during sintering.

After the silicon carbide is converted to an amorphous state, the temperature inside the sintering furnace may be increased to less than or equal to about 1700° C. and, more particularly, between about 1400° C. and about 1600° C. to form B-SiC and to densify the metal oxide. For example, the sintering furnace may be held at about 1500° C. for about 1 hour. The temperature within the sintering furnace may be reduced to about 600° C. and gas mixture comprising oxygen in an inert gas (e.g., argon gas) or a combination of carbon dioxide (CO₂) and carbon monoxide (CO) may be introduced into the sintering furnace. The temperature within the sintering furnace may then be held at about 600° C. for about 1 hour until the fully sintered three-dimensional solid bodies of a MO₂/SiC composite material are formed. During the sintering process, exposure of the silicon carbide to oxygen may result in formation of a silicon oxide material on exposed surfaces of the sintered three-dimensional solid bodies of a MO₂/SiC composite material.

The MO₂/SiC composite material exhibits a substantially increased thermal conductivity in comparison to conventional uranium or uranium dioxide nuclear fuels. The interlaced matrix of the metal oxide material, the silicon carbide material and, if present, the carbon material, provide increased thermal energy transport within and to outer regions of the solid bodies of the MO₂/SiC composite material. Silicon carbide has a higher temnerature thermal shock resistance and significantly higher mechanical strength than uranium dioxide. Thus, interlacing the silicon carbide material with the metal oxide material (e.g., uranium dioxide) imparts the MO₂/SiC composite material with increased thermal conductivity, mechanical strength and thermal shock resistance in comparison to conventional uranium dioxide fuels. In embodiments in which the carbon powder is included in the MO₂/SiC composite material, the carbon powder may function as a getter material integrally formed therein.

Embodiments of the present disclosure may facilitate the production of relatively dense ceramic composite materials and bodies of a metal oxide, silicon carbide and, optionally, a carbon using low-pressure or pressureless sintering techniques, which exhibit improved burn-up properties relative to previously known uranium dioxide fuels. Embodiments of the present disclosure may facilitate the production of ceramic composite materials and bodies of a metal oxide, silicon carbide and, optionally, carbon having relatively complex geometries that exhibit improved physical and chemical properties relative to previously known materials and bodies of uranium dioxide having comparable complex geometries.

Although embodiments of the present disclosure may be used to provide nuclear fuel bodies, embodiments of the present disclosure may be used to fabricate any composite material or body including MO₂/SiC composite material, and is not limited to the fabrication of nuclear fuel.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is to cover all modifications, equivalents, and alternatives falling within the scope of the disclosure as defined by the following appended claims and their legal equivalents.

What is claimed is:

1. A method of forming a composite material, comprising:
forming a first region comprising a metal oxide powder adjacent a second region comprising a silicon carbide powder to form a precursor structure;
removing portions of the precursor structure to form a plurality of segments, each segment comprising a portion of the first region and the second region;
aggregating the plurality of segments to form a green body; and
sintering the green body to form a sintered body.

2. The method of claim 1, wherein forming a precursor structure having a first region comprising a metal oxide powder and a second region comprising a silicon carbide powder comprises:
combining the silicon carbide powder with a preceramic polymer to form to form a slurry of the silicon carbide powder;
depositing a layer of the slurry of the silicon carbide powder to form the first region;
combining a uranium dioxide powder with the preceramic polymer to form a shiny of the uranium dioxide powder; and
forming a layer of the slurry of the uranium dioxide powder over the layer of the slurry of the silicon carbide powder to form the second region.

3. The method of claim 1, wherein forming a first region comprising a metal oxide powder adjacent a second region comprising a silicon carbide powder to form a precursor structure further comprises forming a third region comprising a carbon powder adjacent at least one of the first and second regions.

4. The method of claim 1, wherein forming a first region comprising a metal oxide powder adjacent a second region comprising a silicon carbide powder to form a precursor structure further comprises forming the second region comprising the silicon carbide powder and at least one sintering aid.

5. The method of claim 1, wherein removing portions of the precursor structure to form a plurality of segments comprises removing portions of the precursor structure to form a plurality of segments having a ratio of the metal oxide power to the silicon carbide powder of between about 95 to 5 and about 75 to 25.

6. The method of claim 1, removing portions of the precursor structure to form a plurality of segments comprises:
rotating the precursor structure on a lathing machine; and
removing the segments from the precursor structure using a cutting tool during the rotating.

7. The method of claim 1, wherein aggregating the plurality of segments to form a green body comprises compressing a plurality of particles to form a green body comprising the first regions interlaced with the second regions.

8. The method of claim 1, further comprising coextruding the green body with another green body comprising a silicon carbide material.

9. The method of claim 1, further comprising tailoring a particle size of the metal oxide powder and the silicon carbide powder such that the first and second regions exhibit substantially equal amounts of shrinkage during the sintering.

10. The method of claim 1, wherein sintering the green body to form a sintered body comprises sintering the green body to form a sintered body comprising interlaced regions of a metal oxide material and a silicon carbide material.

11. A method of forming a composite material, comprising:
forming at least one layer of silicon carbide particles;
forming at least one layer of metal oxide particles over the at least one layer of silicon carbide particles to form a stacked structure;
shaping the stacked structure into a cylindrical rod;
removing portions of cylindrical rod to form a plurality of segments, each segment comprising a portion of each of the at least one layer of silicon carbide particles and the at least one layer of the metal oxide particles;
applying pressure to the plurality of segments to form a green body; and
sintering the green body to form a sintered body comprising regions of metal oxide and silicon carbide.

12. The method of claim 11, wherein forming at least one layer of silicon carbide particles comprises:
mixing uranium dioxide particles with a preceramic polymer to form a slurry; and
depositing the slurry over the at least one layer of silicon carbide particles.

13. The method of claim 11, further comprising forming at least one carbon layer over the at least one layer of silicon carbide particles before forming the at least one layer of metal oxide particles.

14. The method of claim 11, wherein applying pressure to the plurality of segments to form a green body comprises applying pressure to the plurality of segments to form a green body comprising regions of the at least one layer of silicon carbide particles interlaced with regions of the at least one layer of metal oxide particles.

15. A method of forming a nuclear fuel, the method comprising:
forming a uranium dioxide material over a silicon carbide material to form a precursor structure;
removing portions of the precursor structure to form a plurality of segments;
applying pressure to the plurality of segments to form a green body; and
sintering the green body to form a sintered body comprising regions of metal oxide and silicon carbide.

16. The method of claim 15, wherein forming a uranium dioxide material over a silicon carbide material to form a precursor structure comprises:
forming a first slurry comprising graphite powder in a preceramic polymer;
forming the first slurry over a second slurry comprising silicon carbide powder in the preceramic polymer; and
forming a third slurry over the first slurry, the third slurry comprising uranium dioxide powder in the preceramic polymer to form the precursor structure.

17. The method of claim 15, further comprising heating the precursor structure to cure the preceramic polymer before removing the portions of the precursor structure to form the plurality of segments.

18. The method of claim 15, wherein removing portions of precursor structure to form a plurality of segments comprises forming the plurality of segments comprising a portion of each of the uranium dioxide material and silicon carbide material.

19. A green body comprising:
metal oxide regions comprising particles of a metal oxide dispersed in a matrix; and
silicon carbide regions at least substantially interlaced with the metal oxide regions and comprising silicon carbide particles dispersed in another matrix.

20. The green body of claim 19, wherein the particles of the metal oxide comprise uranium dioxide particles.

21. The green body of claim 19, wherein the matrix and the another matrix each comprise a cured polysilazane material.

22. The green body of claim 19, further comprising graphite regions at least substantially interlaced with the metal oxide regions and the silicon carbide regions.

23. A nuclear fuel comprising:
a multi-matrix composite material having a pellet shape, the multi-matrix material comprising:
a plurality of uranium dioxide regions; and
a plurality of silicon carbide regions interlaced with the plurality of uranium carbide regions.

24. The nuclear fuel of claim 23, further comprising a silicon carbide material disposed adjacent at least a portion of the multi-matrix composite material.

25. The nuclear fuel of claim 23, wherein the uranium dioxide regions each comprise uranium dioxide particles dispersed in a matrix of silicon carbide.
